(19) United States
(12) Patent Application Publication
(10) Pub. No.: US 2014/0235264 A1
(43) Pub. Date: Aug. 21, 2014

(54) MODIFYING NAVIGATION ASSISTANCE PARAMETERS OF A MOBILE-BASED POSITIONING CAPABILITY BASED ON OBSERVATIONS GATHERED BY A NETWORK-BASED POSITIONING CAPABILITY

(71) Applicant: QUALCOMM INCORPORATED, San Diego, CA (US)

(72) Inventors: Sai Pradeep Venkatraman, Santa Clara, CA (US); Lionel Jacques Garin, Palo Alto, CA (US); Gengsheng Zhang, Cupertino, CA (US)

(73) Assignee: QUALCOMM INCORPORATED, San Diego, CA (US)

(21) Appl. No.: 13/768,977

(22) Filed: Feb. 15, 2013

(51) Int. Cl. H04W 4/02

(52) U.S. Cl. CPC H04W 4/02
USPC 455/456.1

(57) ABSTRACT

Various methods, apparatuses and/or articles of manufacture are provided which may be implemented to obtain navigation assistance parameters (NAP) for a mobile device for use by the mobile device in estimating its movement and/or position within a particular environment based, at least in part, on wireless signal(s) acquired by the mobile device as part of a mobile-based positioning (MBP) capability, and modifying the NAP based, at least in part, on observations of movements and/or positions of a plurality of mobile devices within the particular environment gathered by a network-based positioning (NBP) capability. Various methods, apparatuses and/or articles of manufacture are provided which may be implemented to obtain and provide at least a portion of such modified NAP to a positioning capability of the mobile device for use in estimating a position and/or a movement of the mobile device.

### BACKGROUND

1. Field

The subject matter disclosed herein relates to electronic devices, and more particularly to methods, apparatuses and articles of manufacture for generating and/or obtaining modified navigation assistance parameters for use in a mobile-based positioning capability.

2. Information

A variety of signal-based positioning techniques have been developed to allow for a position and/or a movement of a mobile device, e.g., such as a cell phone, a tracking device, etc., to be determined based on wireless signals that are transmitted by the mobile device and acquired by one or more external receivers, and/or wireless signals that are transmitted by one or more external transmitters and acquired by the mobile device.

For example, by measuring certain characteristics of one or more wireless signals that have been transmitted and acquired, it may be possible to determine a pseudorange or range between the transmitting and receiving antennas. For example, in certain implementations a propagation time may be determined which corresponds to an estimated range or pseudorange between a transmitter and receiver. Consequently, if a position of a transmitter is known or otherwise determinable or alternatively a position of a receiver is known or otherwise determinable, then a range or pseudorange between the antennas of the transmitter and the receiver may be identified. Moreover, once a plurality of such ranges or pseudoranges has been determined, then trilateration or other like known techniques may be implemented to determine an estimated position of the mobile device.

With this in mind, one type of signal-based positioning technique that has been widely implemented to determine a position of a mobile device is the global-based positioning system (GPS) which may be considered as supporting a satellite positioning system (SPS) capability. Here, for example, a SPS receiver may be provisioned within a mobile device to acquire SPS signals from a plurality of SPS transmitters having positions that may be known or determinable. Accordingly, mobile device with an SPS receiver may be capable of determining its estimated position (e.g., with regard to an earth centered, and/or other like coordinate system, etc.) based, at least in part, on a range or pseudorange between the SPS receiver and the applicable SPS transmitters.

### SUMMARY

In accordance with certain aspects, using one or more computing platforms, a method may be implemented which comprises: obtaining navigation assistance parameters (NAP) for a mobile device within a particular environment, the NAP for use, at least in part, by the mobile device to estimate its movement and/or position within the particular environment based, at least in part, on one or more wireless signals acquired by the mobile device as part of a mobile-based positioning (MBP) capability; modifying the NAP based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and providing at least a portion of the modified NAP to at least one electronic device of the MBP capability.

In accordance with certain other aspects, an apparatus may be provided which comprises: means for obtaining navigation assistance parameters (NAP) for a mobile device within a particular environment, the NAP for use, at least in part, by the mobile device to estimate its movement and/or position within the particular environment based, at least in part, on one or more wireless signals acquired by the mobile device as part of a mobile-based positioning (MBP) capability; means for modifying the NAP based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and means for providing at least a portion of the modified NAP to at least one electronic device of the MBP capability.

In accordance with still other aspects, an apparatus may be provided which comprises a communication interface and a processing unit. The processing may: access navigation assistance parameters (NAP) for a mobile device within a particular environment, the NAP for use, at least in part, by the mobile device to estimate its movement and/or position within the particular environment based, at least in part, on one or more wireless signals acquired by the mobile device as part of a mobile-based positioning (MBP) capability; modify the NAP based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and initiate transmission of at least a portion of the modified NAP to at least one electronic device of the MBP capability via the communication interface.

In accordance with some others aspects, an article of manufacture may be provided which comprises a non-transitory computer readable medium having stored therein computer implementable instructions executable by at least one processor in a network-based positioning (NBP) capability to: obtain navigation assistance parameters (NAP) for a mobile device within a particular environment, the NAP for use, at least in part, by the mobile device to estimate its movement and/or position within the particular environment based, at least in part, on one or more wireless signals acquired by the mobile device as part of a mobile-based positioning (MBP) capability; modify the NAP based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and initiate transmission of at least a portion of the modified NAP to at least one electronic device of the MBP capability.

In accordance with another aspect, using one or more computing platforms in a mobile-based positioning (MBP) capability, a method may be implemented which comprises: obtaining navigation assistance parameters (NAP) for a mobile device within a particular environment from at least one electronic device, wherein at least a portion of the NAP has been modified based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and providing at least a portion of the modified NAP to a positioning capability of the mobile device for use in estimating a position and/or a movement of the mobile device within the particular environment based, at least in part, on one or more wireless signals acquired by the mobile device as part of the MBP capability.

In accordance with some aspects, an apparatus for use in providing a mobile-based positioning (MBP) capability may comprise: means for obtaining navigation assistance parameters (NAP) for a mobile device within a particular environment from at least one electronic device, wherein at least a portion of the NAP has been modified based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and means for providing at least a portion of the modified NAP to a positioning capability of the mobile device for use in estimating a position and/or a movement of the mobile device within the particular environment based, at least in part, on one or more wireless signals acquired by the mobile device as part of the MBP capability.

In accordance with yet some other aspects, an apparatus for use in a mobile-based positioning (MBP) capability may be provided which comprises a communication interface and one or more processing units. Here, for example, the processing unit(s) may: obtain, via the communication interface, navigation assistance parameters (NAP) for a mobile device within a particular environment from at least one electronic device, wherein at least a portion of the NAP has been modified based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and provide at least a portion of the modified NAP to a positioning capability of the mobile device for use in estimating a position and/or a movement of the mobile device within the particular environment based, at least in part, on one or more wireless signals acquired by the mobile device as part of the MBP capability.

In accordance with some others aspects, an article of manufacture may be provided which comprises a non-transitory computer readable medium having stored therein computer implementable instructions executable by at least one processor in a mobile-based positioning (MBP) capability to: obtain navigation assistance parameters (NAP) for a mobile device within a particular environment from at least one electronic device, wherein at least a portion of the NAP has been modified based, at least in part, on observations of movements and/or positions of a plurality of mobile devices within the particular environment gathered by a network-based positioning (NBP) capability, wherein at least a portion of the observations is based, at least in part, on one or more signal characteristics for one or more signals transmitted by at least one of the plurality of mobile devices and acquired by at least one receiver; and provide at least a portion of the modified NAP to a positioning capability of the mobile device for use in estimating a position and/or a movement of the mobile device within the particular environment based, at least in part, on one or more wireless signals acquired by the mobile device as part of the MBP capability.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating a system in which a mobile-based positioning (MBP) capability of a mobile device uses one or more navigation assistance parameters (NAP) that have been modified based on observations of positions and/or movements of other mobile devices as gathered by a network-based positioning (NBP) capability, in accordance with an example implementation.

FIG. 2 is a schematic block diagram illustrating certain processing capabilities for generating modified NAP and/or a subset thereof, in accordance with an example implementation.

FIG. 3 is a timeline diagram illustrating communications between representative electronic devices wherein an MBP capability generates modified NAP and/or a subset thereof for use by a mobile device as part of the MBP capability, in accordance with an example implementation.

FIG. 4 is a timeline diagram illustrating communications between representative electronic devices wherein an electronic device generates modified NAP and/or a subset thereof for use by a mobile device as part of the MBP capability, in accordance with an example implementation.

FIG. 5 is a timeline diagram illustrating communications between representative electronic devices wherein at least one electronic device of an NBP capability generates modified NAP and/or a subset thereof for use by a mobile device as part of an MBP capability, in accordance with an example implementation.

FIG. 6 is a timeline diagram illustrating communications between representative electronic devices wherein a mobile device generates modified NAP and/or a subset thereof for use by the mobile device as part of an MBP capability, in accordance with an example implementation.

FIG. 7 is a flow diagram illustrating an example process that may be implemented in at least one computing platform to generate modified NAP, in accordance with an example implementation.

FIG. 8 is a flow diagram illustrating an example process that may be implemented in at least one computing platform to obtain and provide modified NAP, and/or at least a selected subset of modified NAP to a mobile device, in accordance with an example implementation.

FIG. 9 is a schematic block diagram illustrating certain features of a computing platform may be provided in a mobile device to make use of at least a subset of modified NAP as part of an MBP capability, in accordance with an example implementation.

FIG. 10 is a schematic block diagram illustrating certain features of a computing platform may be provided in an electronic device to provide modified NAP, and/or at least a subset of modified NAP to at least one other electronic device and/or a mobile device, in accordance with an example implementation.

### DETAILED DESCRIPTION

A mobile device may be provisioned with a satellite positioning system (SPS) receiver capable of acquiring SPS signals transmitted by a global navigation satellite system (GNSS) (e.g., GPS, etc.), a regional navigation satellite system, and/or the like or some combination thereof. Accordingly, a mobile device may estimate its position and/or movement provided that an applicable number of SPS signals are acquired.

A mobile device may also or alternatively be provisioned with one or more receivers and/or transceivers capable of supporting signal-based positioning techniques using wireless signals acquired from one or more wireless communication and/or computing networks. For example, such a mobile device may be provisioned with a mobile positioning (MBP) capability. An MBP capability may, for example, allow for a mobile device to estimate its position and/or movement based, at least in part, on one or more wireless signals transmitted by one or more transmitters having known or otherwise determinable positions and acquired by the mobile device. For example, an MBP capability may estimate its position and/or movement (e.g., with regard to the known positions of the transmitters, applicable coordinate system, etc.) based, at least in part, on a range or pseudorange between the applicable transmitters and the mobile device.

An MBP capability may, for example, allow for position and/or movement determinations based solely on signals acquired by the mobile device. However, in certain implementations, an MBP capability may also make use of bidirectional wireless communications between the transmitters (which would include receivers) and the mobile device. For example, a round trip time (RTT) may be measured for a wireless signal exchange between the mobile device and a transmitting/receiving device within a wireless communication and/or computing network.

It should be understood that in certain example implementations, an MBP capability may be performed on-board the mobile device without processing assistance from other electronic devices. Conversely, in other example implementations, a mobile device may obtain processing assistance from one or more other electronic devices provisioned to support certain MBP capabilities. As described in greater detail herein, in certain instances an MBP capability and/or other like navigation processes provided, in whole or in part, by mobile device may obtain and/or otherwise use one or more navigation assistance parameters to estimate its position and/or movement within a particular environment.

In certain instances, a position and/or movement of the mobile device may be estimated using a network-based positioning (NBP) capability. An NBP capability may, for example, be provisioned, in whole or in part, in one or more electronic devices, which may be part of, or possibly connected to, a wireless communication and/or computing network. With an NBP capability, a position and/or movement of the mobile device may be estimated based, at least in part, on one or more wireless signals transmitted by the mobile device and acquired by one or more receivers having known or otherwise determinable positions. Accordingly, an NBP capability may be capable of determining an estimated position and/or movement of a mobile device (e.g., with regard to the known positions of the receivers, applicable coordinate system, etc.) based, at least in part, on a range or pseudorange between the applicable receivers and the mobile device.

By way of example, many cellular communication networks make use of an NBP capability to determine a current position of a mobile device in support of emergency 911 (E-911) services, and/or the like. An NBP capability may, for example, allow for position determination based solely on signals transmitted by the mobile device. However in certain implementations, an NBP capability may also make use of bidirectional wireless communications between the receivers (which would include transmitters) and the mobile device.

It should be understood that in certain implementations, a position and/or movement of the mobile device may be estimated based, at least in part, by combining certain information (e.g., pseudorange is and/or ranges, etc.) obtained using one or more SPS, MBP, and/or NBP capabilities, and/or the like.

In accordance with certain aspects of the present description, one potential benefit to having an NBP capability and an MBP capability available for use within a particular environment, is that certain information about all or part of the particular environment may be determined based, at least in part, on previous positions and/or movements for one or more other mobile devices therein. Hence, as described in greater detail herein, in certain instances other types of information that may be available in and/or otherwise determinable by an NBP capability may be used, at least in part, to affect one or more navigation assistance parameters that may be considered by an MBP capability. Accordingly, an MBP capability may be improved in some manner based on information obtained, at least in part, through an MBP capability.

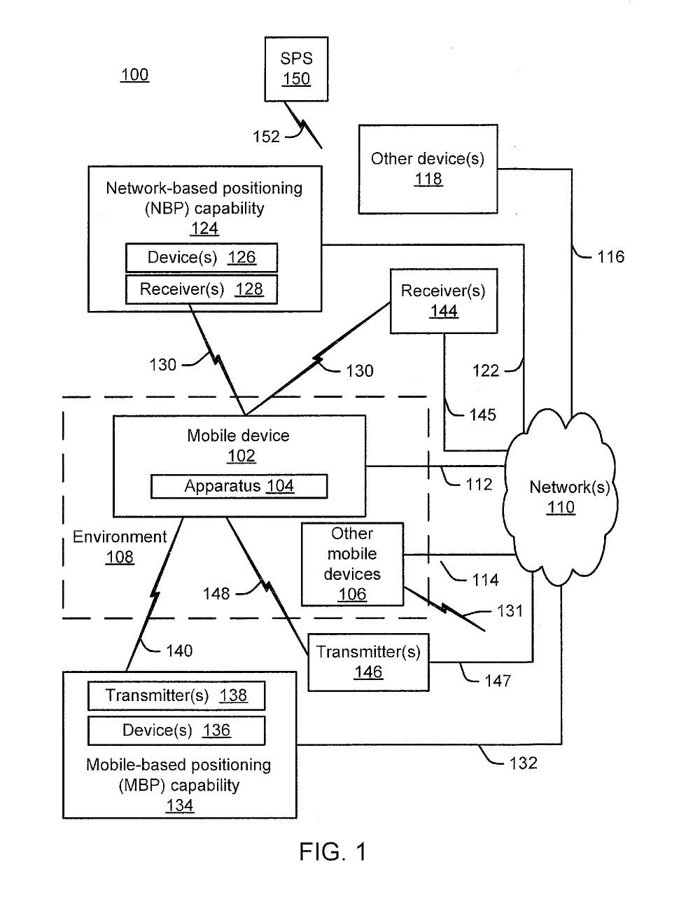

Attention is now drawn to FIG. 1, which presents a schematic diagram illustrating a system 100 in which an estimated position of a mobile device 102 with regard to a particular environment (e.g., environment 108) may be determined using different positioning capabilities based on the transmission and/or reception of certain wireless signals. For example, as described below, an estimated position of mobile device 102 may be determined, at least in part, using a satellite positioning system (SPS) capability, a network-based positioning (NBP) capability, and/or mobile-based positioning (MBP) capability, just to name a few examples.

Thus, in certain instances an estimated position of mobile device 102 may be determined based, at least in part, on one or more SPS signals 152 acquired by mobile device 102 (e.g., via an onboard SPS receiver) from one or more SPS 150. Here, for example, as well known a mobile device may estimate its position and/or movement based on pseudorange(s) to one or more satellites and/or other like transmitters that are part of one or more SPS 150, the positions of which are known or otherwise determinable.

In another example, in certain instances a position and/or movement of mobile device 102 may be determined based, at least in part, on one or more signals 130 transmitted by mobile device 102 and acquired by one or more external receivers, such as, e.g. receiver(s) 128 of an NBP capability 124, and/or receiver(s) 144. Here, for example, as well known one or more electronic devices of NBP capability 124 may determine an estimated position of a mobile device based, at least in part, on one or more signal characteristics (e.g., strength characteristics, timing characteristics, phase characteristics, etc.) for one or more of signals 130 as acquired by one or more receivers (e.g., 128 and/or 144).

In yet another example, in certain instances a position and/or movement of mobile device 102 may be determined based, at least in part, on one or more signals 140 or 148 transmitted by one or more transmitter(s) 138 of an MBP capability 134, or transmitter(s) 146, respectively. Here, for example, as well known an estimated position of a mobile device may be determined based, at least in part, on one or more signal characteristics (e.g., strength characteristics, timing characteristics, phase characteristics, etc.) for one or more of signals 140 and/or 148 as acquired by the mobile device from one or more transmitter(s) 138 or 146 having known or otherwise determinable positions. The processing of MBP capability 134 may be performed in whole or in part by mobile device 102. In certain instances, at least a portion of such processing may be performed by one or more electronic devices 136, and/or the like.

Thus, for example, in certain instances one or more signal characteristics may be used to estimate a range between a transmitter 138 or 146 (e.g., having known position) and mobile device 102. To support and/or otherwise enhance MBP capability 134, one or more navigation assistance parameters (NAP) may be provided for use by mobile device 102 in estimating its position and/or movement with regard to environment 108. At least a portion of the NAP may, for example, be informative and/or indicative of information that may be used by mobile device 102 in determining its position and/or movement within environment 108 based, at least in part, on one or more wireless signals 140 or 148 that may be acquired by mobile device 102, e.g., as part of an MBP capability 134.

By way of example, NAP may comprise information identifying certain expected signal characteristics for one or more transmitters (138, 146) arranged to transmit signals within at least a portion of environment 108, and/or information identifying a known position of one or more transmitters (138, 146) with regard to environment 108 (e.g., such transmitters may be physically located within environment 108 or outside of the environment 108). Thus, in certain instances, NAP may comprise all or part of a probability radio heatmap and/or the like corresponding to one or more transmitters (138, 146).

By way of further example, NAP may comprise information identifying certain aspects relating to all or part of environment 108. For example, NAP may comprise an electronic map and/or the like corresponding to all or part of environment 108. Thus, in certain instances, NAP may comprise an electronic map identifying certain objects, obstructions, pathways, points of interest, etc., pertaining to an outdoor environment, an indoor environment, and/or some combination thereof. Hence, in certain instances NAP may comprise an electronic map indicating certain obstacles and/or attractions that may affect navigation and/or movement by a person or machine carrying mobile device 102 within environment 108. Thus, for example, NAP may comprise a routability graph and/or the like for use in estimating movements and/or positions of mobile device 102 within environment 108, and/or otherwise supporting other like navigation capabilities (e.g., routing, tracking, etc.) with regard to mobile device 102 with regard to all or part of environment 108.

Of course, as with all of the other examples provided herein, claimed subject matter is not intended to necessarily be limited to just these examples above. Hence, it should be recognized that NAP may comprise information corresponding to a variety of different aspects relating to environment 108, mobile device 102, NBP capability 124, MBP capability 134, network(s) 110, receiver(s) 144, transmitter(s) 146, other device(s) 118, and/or any other computing and/or communication resources as represented in example arrangement 100 of FIG. 1 and/or their equivalents. Further, NAP may comprise information corresponding to a particular user/person, machine, or a particular service-related/access account related thereto.

Now, let us consider NBP capability 124 which, like MBP capability 134, may also be used to determine a position and/or movement of mobile device 102 In certain instances, such as that depicted in arrangement 100, information may be available within NBP capability 124 with regard to some aspect of environment 108 which may be beneficial to MBP capability 134, and/or mobile device 102. For example, NBP capability 124 may gather observations regarding the movements and/or positions of a plurality of other mobile devices 106 over time, and based on such observations determine and/or otherwise infer certain information about environment 108.

As such, in accordance with certain aspects, various techniques are provided herein through which all or part of the NAP (e.g., of an MBP capability 134) may be modified based, at least in part, on observations (e.g., gathered by NBP capability 124) of previous and/or current movements and/or positions of a plurality of mobile devices within environment 108. Thus, for example, in certain instances at least a portion of the observations gathered by NBP capability 124 may be based, at least in part, on one or more signal characteristics for one or more signals 131 transmitted by at least one of a plurality of other mobile devices 106 and acquired by at least one receiver (e.g., receiver(s) 128 of NBP capability 124, and/or receiver(s) 144).

Accordingly, certain resulting “modified NAP” may comprise/or be based on historical information gathered from signals transmitted by other mobile devices and more specifically their experience with regard to navigating environment 108. Thus, for example, modified NAP may provide for updating and/or augmentation of an electronic map, a routability graph, and/or the like that may be available in MBP capability 134 with regard to all or part of environment 108.

For example, an electronic map and/or routability graph of NAP (e.g., which may be provided by MBP capability 134) may indicate that a particular pathway may be available for navigation. However, such information may no longer be valid. As such, analysis of recently gathered observations from a plurality of mobile devices may indicate or otherwise lead to an inference that such a pathway may be unavailable. Thus, a corresponding electronic map and/or routability graph in the modified NAP may instead indicate (e.g. through modification and/or augmentation of information) that such particular pathway may be unavailable (e.g., permanently closed, temporarily closed, etc.) or possibly conditionally available (e.g., open during certain periods, has limited access, etc.), e.g., as determined by analysis of the observations gathered by NBP capability 124.

Similarly, a probability radio heatmap and/or the like of NAP (e.g., which may be provided by MBP capability 134) may be indicative of the presence, position and/or operation of a particular transmitter (e.g., transmitter(s) 138 of MBP capability 134, and/or transmitter(s) 146) that may be available for use by an MBP capability positioning capability of mobile station 102. However, such information may no longer be valid. As such, analysis of recently gathered observations from a plurality of mobile devices may indicate that such a transmitter may be unavailable at times, may have had its position changed, may be operating differently, etc. Accordingly, for example, a corresponding probability radio heatmap and/or the like in the modified NAP may instead indicate (e.g. through modification and/or augmentation of information) that such particular transmitter may be unavailable, available at certain times, located at a particular position, and/or otherwise operating in some different manner, just to name a few examples. Accordingly, modified NAP may comprise and/or be based on more current and/or possibly more accurate information regarding the signaling conditions likely to be experienced by mobile device 102 within all or part of environment 108, with regard to one or more transmitters.

With such potential improvements in mind, in accordance with certain example implementations, all or part of the NAP of MBP capability 134 may be obtained and then modified by at least one computing platform. For example, NAP may be obtained by a computing platform from one or more electronic devices, such as, e.g., electronic device(s) 136 of MBP capability 134. Such a computing platform(s) may generate modified NAP and provide at least a portion of the modified NAP to at least one electronic device. In certain example implementations, at least portion of the modified NAP may be provided to at least one electronic device of MBP capability 134, such as, e.g., one or more electronic device(s) 136. Here, for example, electronic device(s) 136 may comprise one or more MBP capability servers, an MBP capability server farm/cloud, and/or the like. Subsequently, at least a portion of the modified NAP may be provided to mobile station 102. However, in certain example implementations, mobile device 102 may be considered to be electronic device that is part of MBP capability 134, and hence such a computing platform may provide at least a portion of the modified NAP to mobile device 102. Indeed, as described in greater detail herein, in certain implementations mobile device 102 may comprise all or part of a computing platform that generates modified NAP or selects a subset thereof for use.

Consequently, at least a portion of the modified NAP may be provided (along with all or part, or possibly even none, of the NAP) to at least one electronic device of the MBP capability and/or (eventually) mobile device 102.

In certain implementations, a further selection process may be implemented (e.g., by one or more electronic device(s) 136 of MBP capability 134) to select a subset of the modified NAP to be provided to mobile station 102. Thus, for example, a subset of the modified NAP may be selected based on various factors associated with mobile device 102, environment 108, timing constraints, memory constraints, communication resources, access requirements, and/or the like or some combination thereof, just to name a few examples. By way of example, a subset of modified NAP may be selected based, at least in part, on one or more attributes of mobile device 102 and/or its user/account, etc., which may render certain modified NAP more or less useful to mobile device 102. For example, if mobile device 102 is unable to acquire a particular type of signal (e.g., based on hardware constraints, access requirements, etc.) then it may be beneficial to select a subset of modified NAP that does not include information about transmitters of such particular type(s) of signal(s). In another example, if an initial estimated position of mobile device 102 places it within a particular region of environment 108, then it may be beneficial to only select a subset of modified NAP corresponding to that particular region of environment 108. In yet other examples, it may be beneficial to select a subset of modified NAP to meet certain file size constraints, communication bandwidth/timing constraints, etc. Of course, these are just a few examples as to when it may be beneficial to select a certain subset of modified NAP to be provided to the mobile device 102.

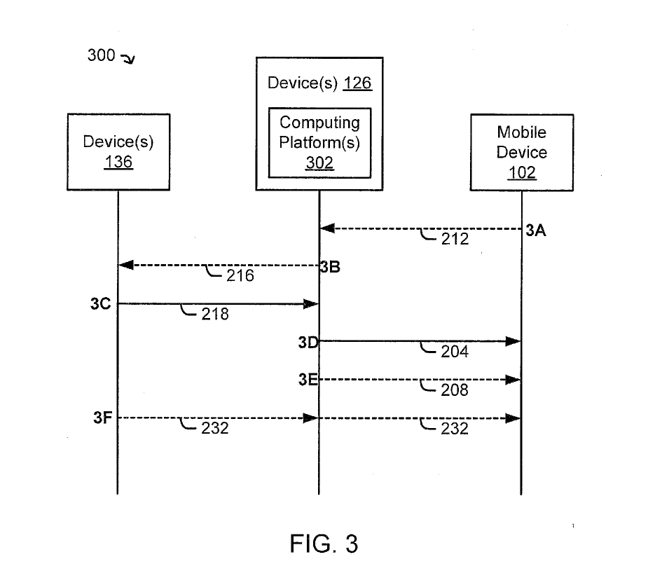

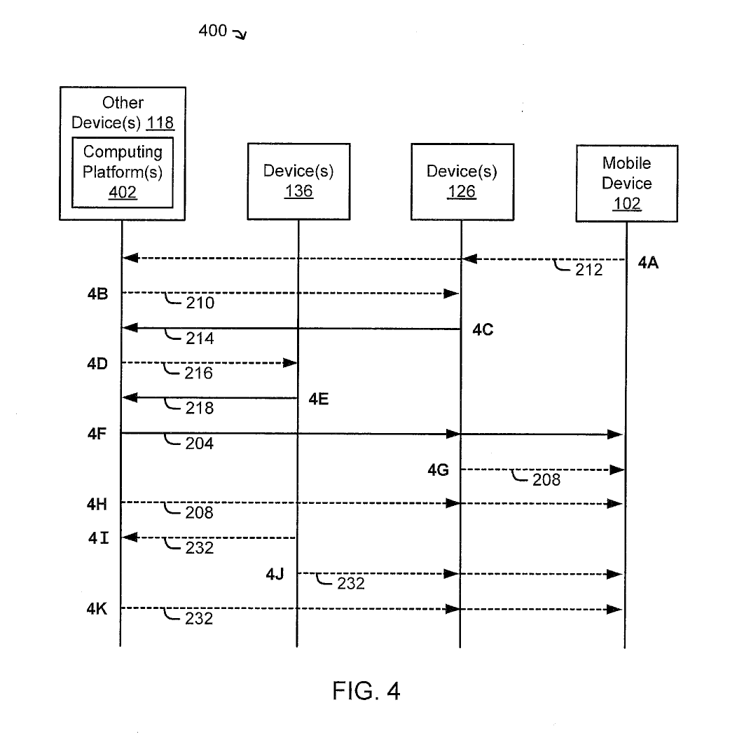

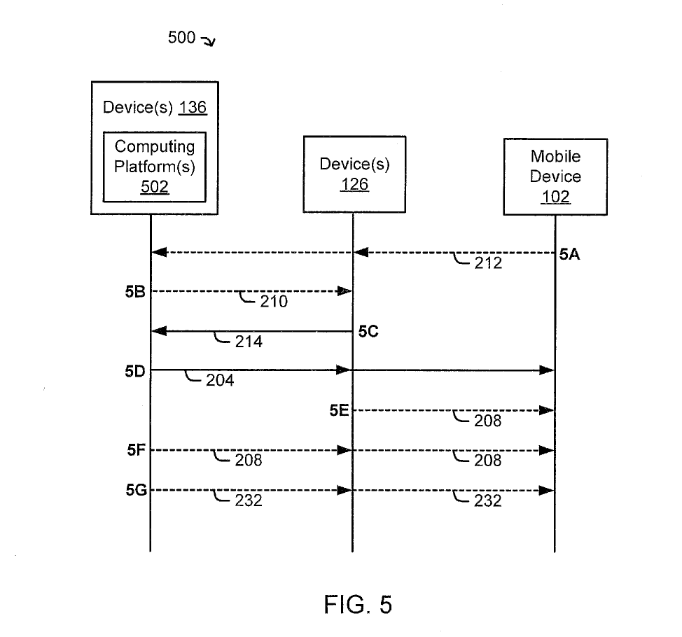

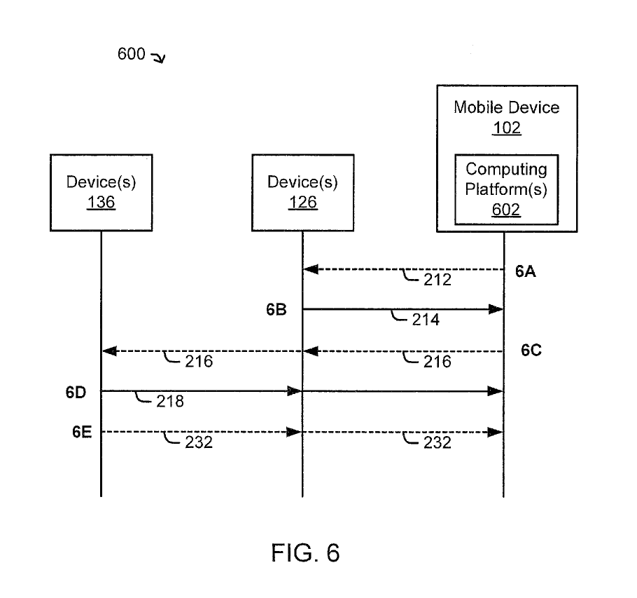

It should be noted that, in the examples above, such a computing platform may be provided in whole or part using various electronic devices. For example, in certain instances an electronic device 126 of NBP capability 124 may comprise all or part of such a computing platform (see, e.g., FIG. 3). In certain instances, an electronic device 136 of MBP capability 134 may comprise all or part of such a computing platform (see, e.g., FIG. 5). In some instances, one or more other device(s) 118 may comprise all or part of such a computing platform (see, e.g., FIG. 4). In still other instances, mobile device 102 may comprise all or part of such a computing platform such a computing platform (see, e.g., FIG. 6).

In the example of FIG. 1, other device(s) 118 is specifically represented as being external to both NBP capability 124 and MBP capability 134, each of which includes example representative electronic device(s) 126 and 136 respectively. As such, other device(s) 118 may represent one or more external electronic devices that may be connected via one or more communication links 116 to network(s) 110, but which may not necessarily be part of NBP capability 124 or MBP capability 134. It should be noted, however, that in some example implementations other device(s) 118 may represent one or more electronic devices that may be part of one or more network(s) 110. Thus, for example, other device(s) 118 represent one or more electronic devices that are part of a cellular communication network, etc.

Similarly, it should be noted that in certain implementations all or part of NBP capability 124 may also be part of one or more network(s) 110. Thus, for example, all or part of NBP capability 124 may be part of a cellular communication network, etc.

Likewise, it should be noted that in certain implementations all or part of MBP capability 134 may be part of one or more network(s) 110. Thus, for example, all or part of MBP capability 134 may be part of a wireless local area network (WLAN), etc.

As described in greater detail below, it may be useful for such a computing platform to further determine a measurement of uncertainty and/or a measurement of accuracy of the movements and/or positions for at least the at least one of the plurality of mobile devices based on the observations gathered by NBP capability 124. Accordingly, the modification of the NAP may be further based, at least in part, on one or more measurements of uncertainty and/or one or more measurements of accuracy.

In accordance with certain example implementations, such a computing platform may specifically request and obtain one or more observations from at least one electronic device 126 and/or at least one receiver 128 of NBP capability 124. For example, if such a computing platform is provided in whole or in part in at least one of other electronic device(s) 118, then such other electronic device 118 may request and/or obtain one or more observations from an electronic device 126 or a receiver 128 of MBP capability 134, e.g., through communication link 116, network(s) 110, and communication link 122.

While communication links 112, 114, 122, 116, 132, 145, and 147 are illustrated in FIG. 1 using solid lines it should be understood that such communication links may comprise various communication devices/resources, and there is wired, fiber and/or wireless communication channels.

In accordance with certain example implementations, such a computing platform may receive a request for NAP from at least one electronic device 136 of the MBP capability 134, and/or possibly mobile device 102. For example, if such a computing platform is provided in whole or in part by other electronic device(s) 118, then such other electronic device 118 may receive a request for NAP from electronic device 136, e.g., through communication link 132, network(s) 110 and communication link 116. In response to such a request and/or for other reasons, such a computing platform may itself transmit a message to one or more electronic device(s) 136 requesting NAP. As described herein, once received such NAP may be modified using the techniques provided herein, and at least portion of the resulting modified NAP may be provided to one or more electronic device(s) 136 and/or mobile device 102.

If, for example, such a computing platform is provided in whole or part on board mobile device 102, then mobile device 102 may transmit a message requesting NAP to electronic device 136. Here, for example, mobile device 102 may transmit a message requesting NAP through communication link 112, network(s) 110 and communication link 132. In other example implementations, mobile device 102 may transmit a message requesting NAP through a wireless communication link directly to a receiver (not shown) that may be provided as part of a communication interface of one or more electronic device(s) 136.

In accordance with certain example implementations, such a computing platform may obtain an initial estimated position of mobile device 102 with respect to environment 108. Here, for example, an initial estimated position may be calculated by such computing platform and/or at another electronic device based, at least in part, on one or more signals 130 transmitted by mobile device 102 and acquired by at least one receiver (e.g., receiver(s) 128 of NBP capability 124, receiver(s) 144, and/or the like). The computing platform or another electronic device may, for example, provide such initial estimated position of the mobile device to at least one electronic device 138 of MBP capability 134, and/or mobile device 102. FIG. 3-6 illustrates some example communications which further illustrate such techniques.

In accordance with certain further aspects, at least one computing platform may be provided in one or more electronic devices 136 of MBP capability 134 to obtain NAP for a mobile device within a particular environment from at least one electronic device. Here, for example, at least a portion of such NAP has already been modified based, at least in part, on observations gathered by NBP capability 124. Accordingly, such a computing platform may subsequently provide at least a portion of such modified NAP to a positioning capability (e.g., represented by apparatus 104) of mobile device 102 for use in estimating a position and/or a movement of mobile device 102 within environment 108 based, at least in part, on one or more wireless signals (e.g. signal(s) 140 from transmitter(s) 138 of MBP capability 134, and/or signal(s) 148 from transmitter(s) 146) acquired by the mobile device, e.g., as part of an MBP capability positioning technique.

For example, one or more of transmitter(s) 138 and/or one or more of transmitter(s) 146 may be provided as part of a dedicated position Beacon transmitting device, a wireless access device (e.g., a wireless access point, a femtocell base station, etc.), and/or the like or some combination thereof.

In this example, as shown, transmitter(s) 146 may be connected to network(s) 110 via one or more communication links 147 which may be wireless and/or wired.

In certain instances one or more of transmitter(s) 138 and/or one or more of transmitter(s) 146 may comprise a communication interface capable of not only transmitting wireless signals but also receiving wireless signals. Similarly, it should be noted that, in certain instances, one or more of receiver(s) 128 and/or one or more of receiver(s) 144 may also have the capability to transmit wireless signals as well. Here, as shown, receiver(s) 144 may be connected to a network(s) 110 via one or more communication links 145, which may be wireless and/or wired.

As previously mentioned, a computing platform may select a subset of modified NAP to be provided to mobile device 102. If needed, such a computing platform may, for example, transmit a request for NAP to at least one electronic device (e.g., one or more devices 136).

In certain instances, a computing platform may obtain an initial estimated position of the mobile device calculated based, at least in part, on one or more signals 130 transmitted by mobile device 102 and received by at least one receiver, e.g., receiver(s) 128 of NBP capability 124, and/or receiver(s) 144.

In certain instances, an MBP server (e.g. represented by electronic device(s) 136) may comprise all or part of such a computing platform. In certain instances, mobile device 102 may comprise all or part of such a computing platform.

As used herein a “mobile device” may represent any electronic device that may be moved about either directly or indirectly by a user within an environment and which may communicate with one or more other devices via one or more wired and/or wireless communication links. Some examples include a cell phone, a smart phone, a computer (e.g., a personal computer such as a laptop computer, tablet computer, a wearable computer, etc.), a navigation aid, a tracking device, a digital book reader, a gaming device, music and/or video player device, a camera, a machine, a robot, etc.

Transmitter(s) 138 and/or transmitter(s) 146 may represent any electronic device capable of at least transmitting and in certain implementations possibly acquiring (e.g., receiving and understanding) one or more wireless signals in one or more wireless communication links. Wireless signals transmitted by transmitter(s) 138 or 146 may be acquired by mobile device 102 for use in positioning, e.g., as part of MBP capability 134. By way of example, in certain implementations, at least one of transmitter(s) 138 or 146 may comprise a service access transceiver (e.g., an IEEE Standard 802.11 access point device and/or other like electronic device that may be part of a wireless local area network and/or other like communication capability). Such a service access transceiver and/or other like electronic device may, for example, provide additional connectivity to one or more other wired and/or wireless networks (e.g., represented by network(s) 110). Such a service access transceiver and/or other like electronic device may, for example, provide direct and/or indirect connectivity (e.g., via one or more networks, etc.) to one or more other computing resources (not shown). Thus, for example, in certain implementations, transmitter(s) 138 and/or 146 may provide mobile device 102 with access to additional communication and/or computing resources.

Regardless of its form, in certain instances, a transmitter(s) 138 or 146 may be uniquely identified and as such identifiable based, at least in part, on one or more signals 140 or 148, respectively. For example, signal 140 transmitted by a transmitter 138 may be indicative of a unique identifier, e.g., a MAC address, etc. Further, transmitter(s) 138 and/or 146 may be arranged to transmit wireless signals from, and receive wireless signals at, a known position. In certain example implementations, a known position of a transmitter 138 or 146 may be determined based, at least in part, on one or more signals 140 or 148 transmitted thereby. For example, in certain instances transmitter 146 may identify all or part of its position in signal 148. Here, for example, a signal 148 may comprise one or more coordinates and/or the like or otherwise be indicative of a position of the antenna(s) of the applicable transmitter. In another example, signal 140 may comprise additional information (e.g., unique identifier, MAC address, etc.) that may be used to determine a known position of a wireless transceiver. Here, for example, one or more coordinates and/or the like which may be indicative of a position of antenna(s) may be determined via a database, lookup table, probability radio heatmap, etc., based, at least in part, on unique identifier for the applicable transmitter.

Network(s) 110 may comprise one or more communication systems and/or data networks having various interconnected devices supporting communication between various electronic devices, e.g. as illustrated in example system 100. In a particular implementation, network(s) 110 may comprise an Internet Protocol (IP) infrastructure and/or the like, which may be capable of facilitating communication between various electronic devices, e.g. as illustrated in example system 100. In another example implementation, network(s) 110 may comprise cellular communication network infrastructure such as, for example, a base station controller or master switching center to facilitate mobile cellular communication with at least mobile device 102.

As illustrated, one or more satellite positioning system systems (SPS) 150 may be provided to transmit one or more wireless positioning signals in the form of one or more SPS signals 152 that may, at times, be acquired by mobile device and used for positioning and/or navigation purposes. SPS 150 may, for example, represent one or more global navigation satellite system (GNSS), one or more regional navigation satellite systems, and/or the like or some combination thereof. In certain implementations, mobile device 102 may receive or acquire SPS signals 152 from SPS satellites (not shown). In some embodiments, SPS satellites may be from one GNSS, such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS') such as, for example, WAAS, EGNOS, QZSS, just to name a few examples.

In particular implementations, mobile device 102 may have circuitry and processing resources capable of computing a position fix (e.g. calculating an estimated location) of mobile device 102. For example, mobile device 102 may compute a position fix based, at least in part, on pseudorange measurements to one or more SPS satellites. Here, mobile device 102 may compute such pseudorange measurements based, at least in part, on of pseudonoise code phase detections in SPS signals 152 acquired from one or more SPS satellites. In particular implementations, mobile device 102 may receive SPS positioning assistance data that may aid in the acquisition of SPS signals 152 transmitted by SPS 150 including, for example, almanac, ephemeris data, Doppler search windows, just to name a few examples.

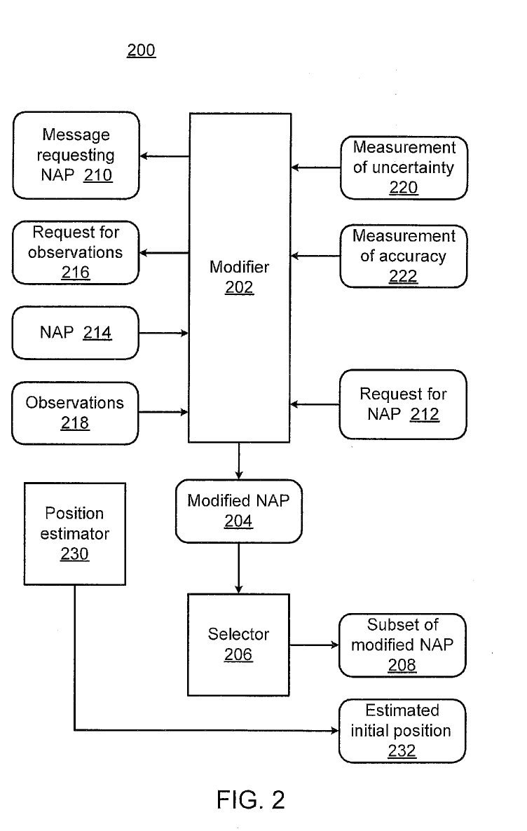

Attention is drawn next to FIG. 2, which comprises a schematic diagram illustrating certain features of an apparatus 200 that may be provided in whole or in part in one or more computing platforms of one or more electronic devices and/or mobile devices to support all or part of the example techniques provided herein.

With regard to system 100 of FIG. 1, in certain implementations all or part of apparatus 200 may be provided in one or more computing platforms of electronic device(s) 136 of MBP capability 134. For example, a computing platform 502 (FIG. 5) provided in electronic device(s) 136 may comprise a modifier 202 and/or a selector 206.

In certain other implementations all or part of apparatus 200 may, for example, be provided in one or more computing platforms of electronic device(s) 126 of NBP capability 124. For example, a computing platform 302 (FIG. 3) provided in electronic device(s) 126 may comprise a modifier 202, a selector 206, and/or a position estimator 230.

In still other implementations all or part of apparatus 200 may, for example, be provided in one or more computing platforms of other device(s) 118. For example, a computing platform 402 (FIG. 4) provided in other device(s) 118 may comprise a modifier 202, a selector 206, and/or a position estimator 230.

In yet other implementations all or part of apparatus 200 may, for example, be provided in one or more computing platforms of mobile device 102. For example, computing platform 602 (FIG. 6) provided in mobile device 102 may comprise a modifier 202, and/or a selector 206.

Modifier 202 represents a processing capability through which at least a portion of NAP 214 may be affected in some manner based, at least in part, on one or more observations 218 to generate at least a portion of modified NAP 204. In certain example implementations, modifier 202 may initiate transmission of a message 210 requesting NAP. For example, message 210 may be transmitted to one or more electronic devices 136 of MBP capability 134 (see FIG. 1).

In certain implementations, modifier 202 may receive a request 212 for NAP, for example from an electronic device 136 of MBP capability 134 and/or mobile device 102. In response to request 212, modifier 202 may initiate transmission of message 210 requesting NAP (if needed).

Modifier 202 may receive NAP 214 from one or more electronic devices (if needed). In certain implementations, NAP 214 may be received in response to message 210. In other implementations, NAP 214 may be received regardless as to whether message 210 is transmitted. Here, for example, one or more electronic devices may be set up to provide NAP 214 at various points in time and/or in response to certain events, etc. In certain example implementations, NAP 214 may be received from one or more electronic devices 136 of MBP capability 134.

Modifier 202 may initiate transmission of a request 216 for observations. For example, request 216 may be transmitted to one or more electronic devices 126 of NBP capability 124 (see FIG. 1).

Modifier 202 may receive observations 218 from one or more electronic devices. In certain implementations, observations 218 may be received in response to request 216. In other implementations, observations to way may be received regardless as to whether request 216 is transmitted. Here, for example, one or more electronic devices may be set up to provide observations 218 at various points in time and/or in response to certain events, etc. In certain example implementations, observations 218 may be received from one or more electronic devices 126 of NBP capability 124.

Modifier 202 may, in certain example implementations, determine or otherwise obtain one or more measurements of uncertainty 220 relating to one or more observations 218. Here, for example, observations 218 may be gathered by NBP capability 124 based, at least in part, on signals 131 acquired by receiver(s) 128, and/or possibly receiver(s) 144. As such, for example, a measurement of uncertainty 220 with regard to an observation may be may be indicative of a level of trustworthiness of the gathered information and/or resulting observation corresponding to the determined movements and/or positions of one or more other mobile devices 106 within environment 108. Thus, for example, a measurement of uncertainty 220 may comprise or be based on a weight and/or other like value, and/or mathematical function corresponding to one or more particular position grid points and/or the like corresponding to an electronic map (e.g., which may be part of a routability graph and/or the like). For example, a measurement of uncertainty 220 for an observation that places a mobile device within an inaccessible area of environment 108 may be indicative of a heightened level of uncertainty relative to another observation that places the mobile device within an accessible area of the environment 108. In another example, a measurement of uncertainty 220 for an observation may be indicative of or based at least in part on, an uncertainty in the determined movements and/or positions of the mobile device as a result of signal interference, multipath signaling, etc., and/or possibly uncertainty relating to a current position of a receiver.

Modifier 202 may, in certain example implementations, determine or otherwise obtain one or more measurements of accuracy 222 relating to one or more observations 218. Here, for example, a measurement of accuracy 222 may identify and accuracy of a determined position, a determined velocity, a determined speed, etc., of one or more other mobile devices 106 within environment 108. Thus, for example, a measurement of accuracy 222 with regard to an observation may be may be indicative of a distance and/or a corresponding wireless signal propagation time, a statistical indicator (e.g., relating to a standard deviation, etc.), and/or the like or some combination thereof with regard to the gathered information and/or resulting observation corresponding to movements and/or positions of one or more other mobile devices 106 within environment 108. As such, in certain example implementations, a measurement of accuracy 222 may simply indicate that a determined position may be accurate to plus or minus two meters, falls within a first standard deviation, etc.

As previously mentioned, modifier 202 may affect all or part of NAP 214 based, at least in part, one or more observations 218 to generate modified NAP 204. Thus, in certain instances, some of modified NAP 204 may comprise a version of NAP 214 that has changed in some manner. For example, some of modified NAP 204 may comprise one or more parameters of a routability graph, probability radio heatmap, etc., which have been changed based on one or more observations 218. In certain other examples, one or more parameters in NAP 214 may not be included in modified NAP 204. Here, for example, information corresponding to a transmitter that appears to have failed or may have possibly been removed, or possibly to a particular route that has been closed, etc., may not be included in modified NAP 204.

Conversely, in other instances, one or more parameters of modified NAP 204 may have been added to add certain information that is missing in NAP 214, and/or otherwise augment certain information in NAP 214. For example, additional information corresponding to a new transmitter, a relocated transmitter, a new pathway, a new route, etc., may be included in modified NAP 204. For example, additional information may be provided to augment a probability radio heatmap to indicate likely dead zones, interferences, etc., which may not have been previously known or properly identified in NAP 214.

As illustrated in FIG. 2, selector 206 may obtain modified NAP 204 and generate at least a subset 208 of modified NAP 204. In certain example implementations, selector 206 may reduce modified NAP 204 in some manner to obtain subset 208. As previously mentioned, in certain implementations, various factors associated with one or more devices and/or capabilities within environment 100 (see FIG. 1) and/or the like may be considered in selecting subset 208. For example, subset 208 may comprise a particular part of modified NAP 204 that may be beneficial to mobile device 102 with regard to a particular region within environment 108, a particular transmitter, a particular receiver, a particular route, a particular user/account, user preferences, a particular period of time, particular data file size, a memory constraint, a particular communication protocol, a communication constraint, a time constraint, some priority scheme, and/or the like or some combination thereof just to name a few examples.

Although not shown in FIG. 2, it should be understood that the various devices and capabilities within system 100 may be connected via one or more direct communication links, and/or indirect communication links, and through such communication capabilities selector 206 may be made aware of various factors that may be taken into consideration in selecting subset 208.

Subset 208 of modified NAP 204 may be provided to mobile device 102, and/or apparatus 104 therein.

Additionally, in certain implementations, a position estimator 230 may be provided to determine an estimated initial position 232 of mobile device 102 based on signals 130 transmitted by mobile device 102 and received by one or more receiver(s) 128, and/or receiver(s) 144. In certain instances, such an estimated initial position may comprise a fairly rough estimation of a position, which should allow apparatus 104 of mobile device 102 to identify particular portions of subset 208 of modified NAP 204, and/or modified NAP 204 that may be of particular use in determining a position fix via MBP capability 134. In certain example implementations, estimated initial position 232 may be indicative of a particular region of environment 108, e.g., part of a coverage area of a particular receiver, a particular cell, etc.

Attention is drawn next to several example timeline diagrams presented in FIG. 3-6, which illustrate possible communications and/or other like exchanges of data/information between certain devices based on certain example distributions processing in accordance with modifier 202, selector 206, and position estimator 230. It should be recognized, however, that the example timeline diagrams presented in FIG. 3-6 are just a few examples and as such claimed subject matter is not necessarily limited to just these examples. Additionally, it should be noted that communications shown in FIG. 3-6 using dashed-lines may, in certain implementations, be optional.

With this in mind, FIG. 3 is a timeline diagram 300 illustrating possible communications between one or more electronic device(s) 136, one or more electronic device(s) 126, and mobile device 102 in support of certain example techniques provided herein. In this example, at least one computing platform 302 is provided in one or more electronic device(s) 126 of MBP capability 134 to generate modified NAP 204 and/or possibly a subset 208 thereof for use by mobile device 102.

At example event 3A, mobile device 102 may transmit a request 212 for NAP to computing platform 302. At example event 3B, computing platform 302 may transmit a request 216 for observations to one or more electronic devices 136. At example event 3C, one or more electronic devices 136 may transmit one or more observations 218 to computing platform 302.

In this example, with the occurrence of example event 3C computing platform 302 has obtained observations 218. It is assumed that computing platform 302 and/or one or more other electronic devices 126 already has access to NAP 214. Accordingly, computing platform 302 may modify all or part of NAP 214 based, at least in part, on one or more observations 218, e.g. as described herein. For example, computing platform 302 may implement all or part of modifier 202.

Consequently, at example event 3D, computing platform 302 may transmit at least a portion of modified NAP 204 to one or more electronic devices 126, and/or (as illustrated) to mobile device 102. In certain implementations, computing platform 302 may select a subset 208 of modified NAP and at example event 3E, transmit subset 208 of modified NAP to mobile device 102. For example, computing platform 302 may implement all or part of selector 206.

In certain implementations, one or more electronic device(s) 136 may determine an estimated initial position 232 of mobile device 102, e.g., based on signals 130 transmitted by mobile device 102, and/or other considerations. Hence, for example, one or more electronic devices 136 may implement all or part of a position estimator 230. As such, at example event 3F, an estimated initial position 232 of mobile device 102 may be transmitted (directly or indirectly) to one or more electronic device(s) 126 and/or to mobile device 102.

Attention is drawn next to example timeline diagram 400 of FIG. 4, which illustrates possible communications between one or more other electronic device(s) 118, one or more electronic device(s) 136, one or more electronic device(s) 126, and mobile device 102 in support of certain example techniques provided herein. In this example, at least one computing platform 402 is provided in one or more other electronic device(s) 118 to generate modified NAP 204 and/or possibly a subset 208 thereof for use by mobile device 102. In this example, it is assumed that computing platform 402 is not a part of MBP capability 134 or NBP capability 124.

At example event 4A, a request 212 for NAP may be transmitted from mobile device 102 and/or one or more electronic device(s) 126 to computing platform 402. At example event 4B, a message 210 requesting NAP may be transmitted from computing platform 402 to one or more electronic device(s) 126. At example event 4C, NAP 214 may be transmitted from one or more electronic device(s) 126 to computing platform 402.

At example event 4D, a request 216 for observations may be transmitted from computing platform 402 to one or more electronic devices 136. At example event 4E, one or more observations 218 may be transmitted from one or more electronic device(s) 136 to computing platform 402.

In this example, with the occurrence of example events 4C and 4E, computing platform 402 has obtained NAP 214 and observations 218, respectively. Accordingly, computing platform 302 may modify all or part of NAP 214 based, at least in part, on one or more observations 218, e.g. as described herein. For example, computing platform 302 may implement all or part of modifier 202.

Consequently, at example event 4F, computing platform 402 may transmit (directly or indirectly) at least a portion of modified NAP 204 to one or more electronic devices 126, and/or to mobile device 102. In certain implementations, computing platform 402 may select a subset 208 of modified NAP and at example event 4H, transmit (directly or indirectly) a subset 208 of modified NAP to one or more electronic devices 126, and/or to mobile device 102. For example, computing platform 402 may implement all or part of selector 206.

In certain other implementations, at least one computing platform (not shown) in one or more electronic device(s) 126 may select a subset 208 of modified NAP and at example event 4G, transmit a subset 208 of modified NAP to mobile device 102. For example, at least one computing platform (not shown) in one or more electronic device(s) 126 may implement all or part of selector 206.

In certain implementations, one or more electronic device(s) 136 may determine an estimated initial position 232 of mobile device 102, e.g., based on signals 130 transmitted by mobile device 102, and/or other considerations. Hence, for example, one or more electronic devices 136 may implement all or part of a position estimator 230. As such, at example event 4I, an estimated initial position 232 of mobile device 102 may be transmitted to computing platform 402, which may then transmit estimated initial position 232 (directly or indirectly) to one or more electronic device(s) 136 and/or to mobile device 102, as illustrated at example event 4K. In certain other implementations, one or more electronic devices 136 may transmit estimated initial position 232 (directly or indirectly) to one or more electronic device(s) 126 and/or to mobile device 102, as illustrated at example event 4J.

Attention is drawn next to FIG. 5, which is a timeline diagram 500 illustrating possible communications between one or more electronic device(s) 136, one or more electronic device(s) 126, and mobile device 102 in support of certain example techniques provided herein. In this example, at least one computing platform 502 is provided in one or more electronic device(s) 126 of MBP capability 134 to generate modified NAP 204 and/or possibly a subset 208 thereof for use by mobile device 102.

At example event 5A, mobile device 102 may transmit (directly or indirectly) a request 212 for NAP to computing platform 502. At example event 5B, computing platform 502 may transmit a message 210 requesting NAP to one or more electronic device(s) 126. At example event 5C, one or more electronic device(s) 126 may transmit at least a portion of NAP 214 to computing platform 502.

In this example, with the occurrence of example event 5D computing platform 502 has obtained NAP 214. It is assumed that computing platform 502 and/or one or more other electronic devices 136 already has access to observations 218. Accordingly, computing platform 502 may modify all or part of NAP 214 based, at least in part, on one or more observations 218, e.g. as described herein. For example, computing platform 502 may implement all or part of modifier 202.

Consequently, at example event 5D, computing platform 502 may transmit (directly or indirectly) at least a portion of modified NAP 204 to one or more electronic device(s) 126, and/or to mobile device 102. In certain implementations, computing platform 502 may select a subset 208 of modified NAP and at example event 5F, transmit (directly or indirectly) subset 208 of modified NAP to one or more electronic device(s) 216, and/or mobile device 102. For example, computing platform 502 may implement all or part of selector 206.

In certain other implementations, at least one computing platform (not shown) in one or more electronic device(s) 126 may select a subset 208 of modified NAP and at example event 5E, transmit a subset 208 of modified NAP to mobile device 102. For example, at least one computing platform (not shown) in one or more electronic device(s) 126 may implement all or part of selector 206.

In certain implementations, one or more electronic device(s) 136 may determine an estimated initial position 232 of mobile device 102, e.g., based on signals 130 transmitted by mobile device 102, and/or other considerations. Hence, for example, one or more electronic devices 136 may implement all or part of a position estimator 230. As such, at example event 5G, an estimated initial position 232 of mobile device 102 may be transmitted (directly or indirectly) to one or more electronic device(s) 126, and/or to mobile device 102.

Attention is drawn next to FIG. 6, which is a timeline diagram 600 illustrating possible communications between one or more electronic device(s) 136, one or more electronic device(s) 126, and mobile device 102 in support of certain example techniques provided herein. In this example, at least one computing platform 602 is provided in mobile device 102 to generate modified NAP 204 and/or possibly a subset 208.

At example event 6A, computing platform 602 may transmit a request 212 for NAP to one or more electronic device(s) 126. At example event 6B, one or more electronic device(s) 126 may transmit at least a portion of NAP 214 to computing platform 602.

At example event 6C, computing platform 602 may transmit (directly or indirectly) a request 216 for observations to one or more electronic device(s) 136. At example event 6D, one or more electronic device(s) 136 may transmit (directly or indirectly) one or more observations 218 to computing platform 602.

In this example, with the occurrence of example events 6B and 6D computing platform 602 has obtained NAP 214 and observations 218, respectively. Accordingly, computing platform 602 may modify all or part of NAP 214 based, at least in part, on one or more observations 218, e.g. as described herein. For example, computing platform 602 may implement all or part of modifier 202.

In certain implementations, one or more electronic device(s) 136 may determine an estimated initial position 232 of mobile device 102, e.g., based on signals 130 transmitted by mobile device 102, and/or other considerations. Hence, for example, one or more electronic devices 136 may implement all or part of a position estimator 230. As such, at example event 6E, an estimated initial position 232 of mobile device 102 may be transmitted (directly or indirectly) to one or more electronic device(s) 126, and/or to mobile device 102.

It should be recognized that the example possible communication scenario and example timelines illustrated in FIG. 3-6 present just a few examples as to how the techniques presented herein may be distributed amongst various example electronic devices, and as such claimed subject matter is not necessarily limited to just these examples. Indeed, it should be clear that the sequences of possible communications with regard to the example timelines may change drastically depending upon a particular implementation, etc. Thus, for example, it should be recognized that such events may be skipped, or occur in different orders, occur concurrently, and/or that certain possible communications may comprise a plurality of unidirectional, bidirectional, or possibly otherwise broadcast communications which may travel over direct or indirect communication links of various types. Additionally, in certain implementations it may be possible to combine various possible communications. Further still, it should be understood that while only certain example electronic devices are illustrated herein, in certain other implementations more or fewer electronic devices and/or other computing/communication resources may be involved in supporting the techniques provided herein.

It should be recognized that MBP capability 134 may make use of signals 140 and/or 148 (see FIG. 1) transmitted by one or more transmitter(s) 138 or 146, respectively, which may be acquired by mobile device 102. For example, apparatus 104 and mobile device 102 may measure an RSSI and/or the like (or one or more other signal characteristics) for signals 140 and/or 148, and based, at least in part, on portions of subset 208 of modified NAP 204, and/or modified NAP 204, determine its estimated position, velocity, speed, etc., with regard to environment 108.

In another example, apparatus 104 may measure a TOF and/or the like for signals 140 and/or 148, and based, at least in part, on portions of subset 208 of modified NAP 204, and/or modified NAP 204, determine its estimated position, velocity, speed, etc., with regard to environment 108.

In yet another example, mobile device 102 may also transmit one or more signals to one or more transmitter(s) 138 and/or one or more transmitter(s) 146 and measure a RTT and/or the like based on such signal exchanges, and based, at least in part, on portions of subset 208 of modified NAP 204, and/or modified NAP 204, determine its estimated position, velocity, speed, etc., with regard to environment 108.

In certain other implementations, apparatus 104 may obtain a rough initial position based, at least in part, on one or more SPS signals 152, one or more signals 140 and/or 148, one or more inertial sensors or environmental sensors on board apparatus 102, information obtained from a user via one or more input/output units, and/or the like or some combination thereof.

In accordance with certain aspects, observations 218 may comprise and/or be based at least in part on positioning statistics and/or other useful information gathered using NBP capability 124 to aid MBP capability 134. More specifically, the techniques presented herein allow for NAP 214 to be possibly modified in some manner based on observations 218. Hence, the resulting modified NAP 204 and/or a subset 208 of modified NAP may be provided to a mobile device and used as part of MBP capability 134. In certain implementations, positioning data, possibly including traffic statistics, mobility patterns, etc. gathered by NBP capability 124 may be used, at least in part, to modify an all or part of NAP 214, such as, e.g. an electronic map, a routability graph, etc., which may improve MBP capability 134. In other instances, as previously mentioned, signaling related information and/or the like gathered by NBP capability 124 may be used to modify a probability radio heatmap, etc.

Although illustrated in FIG. 1, as being separate, it should be recognized that in certain instances certain electronic devices may be provided which are part of NBP capability 124 and MBP capability 134. By way of example, in certain implementations, one or more electronic devices may be provisioned for use with both MBP capability 134 and NBP capability 124. Accordingly, in this or other implementations it may be particularly beneficial for an electronic device that supports both MBP capability 134 and NBP capability 124 to assist in collecting observations corresponding to certain information, such as, e.g., user information, etc., that that may be useful to MBP capability 134. Similarly, it should be understood that in certain implementations, one or more transmitters and/or receivers may also be provisioned as a shared resource for use with both MBP capability 134 and NBP capability 124.

In certain example implementations, as part of NBP capability 124 a positioning server may be provisioned to direct receiver(s) 128 and/or other like electronic devices to measure RSSIs and/or determine ranges to a mobile device and use such measurements to compute a position fix for the mobile device. As such, NBP capability 124 may be used for locating and tracking users, assets, and/or to provide for E-911 services, just to name a few examples.

In certain implementations, NBP capability 124 may, for example, locate users in order to send them advertisements, coupons, and/or the like which may be location specific. In addition, NBP capability 124 may in certain instances aggregate position fixes, quality metrics, etc., that may be of use in analyzing user traffic, mobility patterns, etc.

In certain example implementations, as part of MBP capability 134, a mobile device may be provisioned with an apparatus 104 to provide measurements of RSSI, ranges, etc., with regard to signals acquired from one or more transmitters. As described herein, in certain instances, such measurements may be improved based, at least in part, on modified NAP 204 and/or a subset 208 of modified NAP. Further, in certain implementations, apparatus 104 may obtain and utilize one or more electronic maps, routability graphs, probability radio heatmap, etc., to determine positioning and/or movements of the mobile device with respect to environment 108, and/or provide other navigation capabilities, e.g., such as routing, etc. Accordingly, as described herein, modified NAP 204 and/or a subset 208 that modified NAP may provide more accurate information, e.g. has gathered over time based on the movements and/or positions of the plurality of other mobile devices 106 within environment 108.

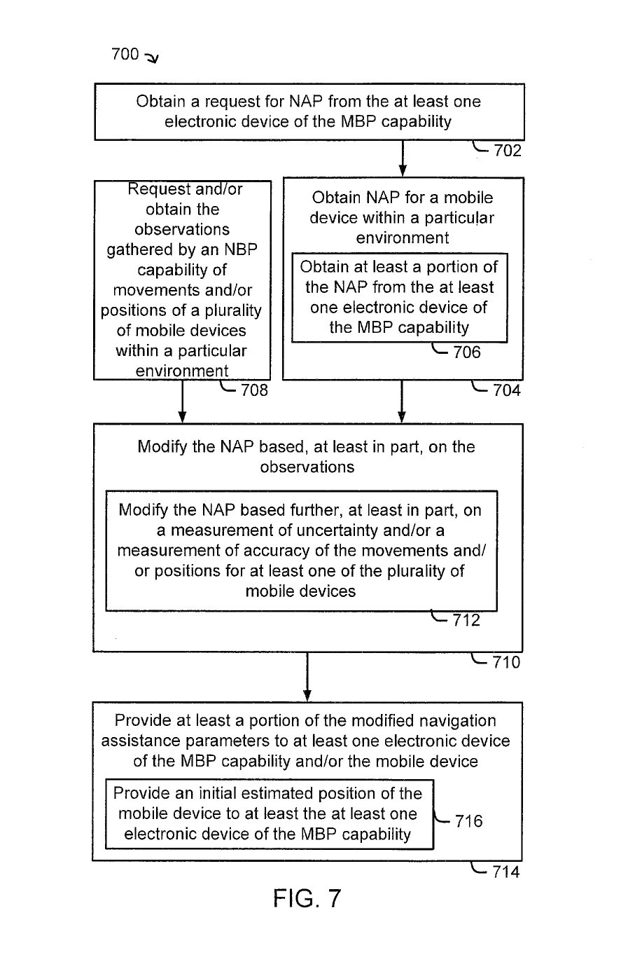

Attention is drawn next to FIG. 7, which is a flow diagram illustrating an example process 700 that may be implemented in at least one computing platform to generate modified NAP, in accordance with an example implementation.

At example block 702, a request 212 for NAP (see FIG. 2) may be obtained from at least one electronic device. In certain instances, such an electronic device may be part of MBP capability 134 (see FIG. 1). For example, a request 212 for NAP may be received from a device 136, and/or a mobile device 102.

At example block 704, NAP 214 (see FIG. 2) for a mobile device within a particular environment may be obtained. In certain instances, at example block 706, at least a portion of such NAP may be obtained from at least one electronic device 136 that is part of MBP capability 134. As previously mentioned, such NAP may comprise a variety of information that may be useful to mobile device in determining its movements and/or positions with regard to the particular environment. Thus, for example, certain NAP may comprise all or part of an electronic map corresponding to the particular environment, a routability graph corresponding to all or part of the particular environment, a probability radio heatmap corresponding to one or more transmitters arranged to transmit signals that may be acquired by mobile device 102 within the particular environment, and/or the like or some combination thereof, again just to name a few examples.

At example block 708, one or more observations 218 (see FIG. 2) of movements and/or positions of one or more of the plurality of mobile devices within the particular environment, as gathered by an MBP capability, may be obtained. For example, one or more such observations may be obtained from one or more electronic devices 126 of MBP capability 134. In certain instances, as previously mentioned, a request 216 for observations may be transmitted to initiate reception of one or more observations 218.

At example block 710, all or part of the NAP 214 obtained via block 704 may be modified (e.g., affected, changed, added, deleted, augmented, etc.) based, at least in part, on one or more of the observations 218 obtained via block 708. In certain example implementations, at block 712, all or part of NAP 214 may be modified based further, at least in part, on one or more measurements of uncertainty 220, and/or one or more measurements of accuracy 222 (see FIG. 2).

At example block 714, at least a portion of the modified NAP 204 (see FIG. 2) may be provided to at least one electronic device 136 of the MBP capability 134 and/or mobile device 102. In certain example implementations, at block 716, an initial estimated position of mobile device 102 may also be provided to the electronic device 136, and/or mobile device 102. Here, for example, as previously mentioned, an initial estimated position of the mobile device may be obtained from one or more devices 126, and/or one or more receivers 128 of NBP capability 124.

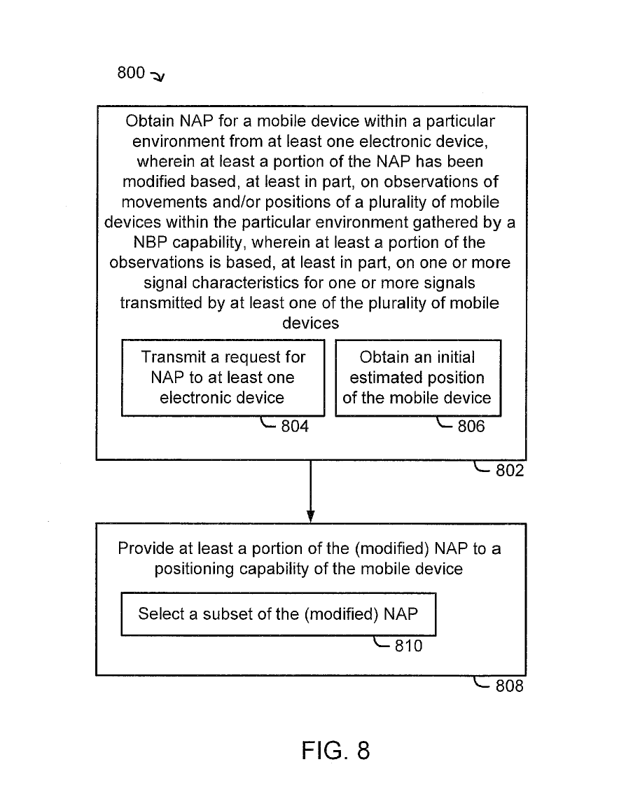

Attention is drawn next to FIG. 8, which is a flow diagram illustrating an example process 800 that may be implemented in at least one computing platform to obtain and provide modified NAP, and/or at least a selected subset of modified NAP to a mobile device, in accordance with an example implementation.

At example block 802, NAP for mobile device within a particular environment may be obtained from at least one electronic device. Here, at least a portion of the NAP may have been modified based, at least in part, on one or more observations of movements and/or positions of a plurality of mobile devices 106 within a particular environment, e.g., as gathered by NBP capability 124. In certain instances, at least a portion of the observations may be based, at least in part, on one or more signal characteristics for one or more signals 131 transmitted by at least one of the plurality of mobile devices 106. In certain instances, at block 804, a request 212 (see FIG. 2) for NAP may be transmitted to at least one electronic device. In certain instances, at block 806, an initial estimated position of the mobile device may be obtained.

At example block 808, at least a portion of the modified NAP 204 may be provided to a positioning capability (e.g., represented by apparatus 104) of mobile device 102. In certain instances, at block 810, a subset 208 of modified NAP 204 may be selected. Thus, for example, the portion of the modified NAP that is provided to the mobile device may be limited to subset 208 in certain instances, while in other instances, a portion of the modified NAP that is provided to the mobile device made comprise additional modified NAP or possibly unmodified NAP in addition to subset 208.

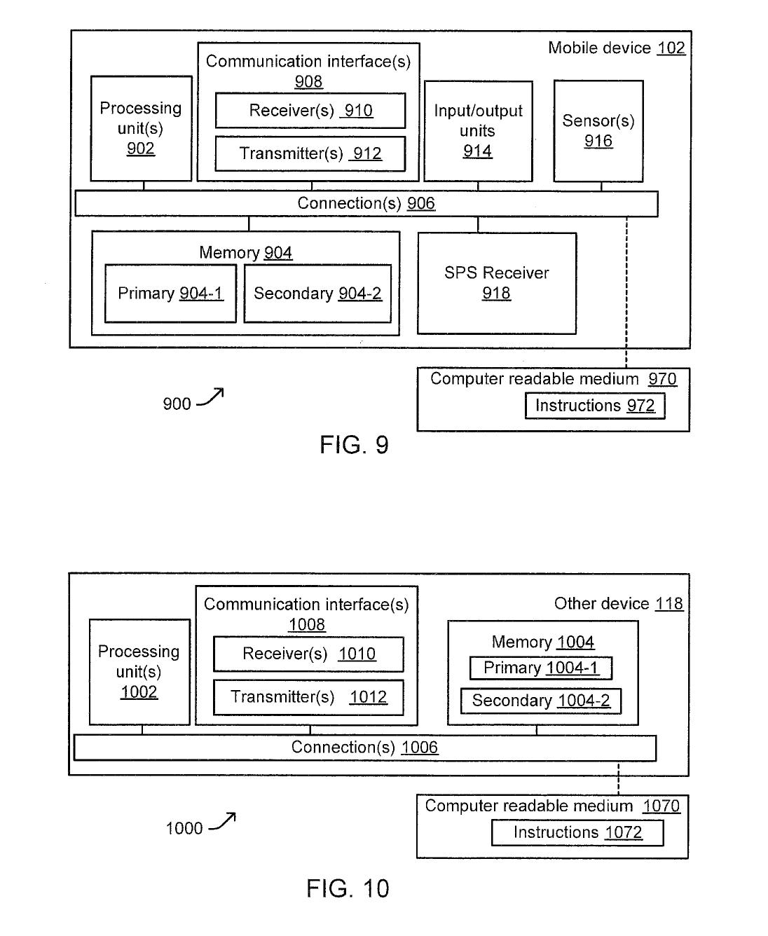

Attention is drawn next to FIG. 9, which is a schematic block diagram illustrating certain features of a computing platform 900 that may be provided in mobile device 102 to make use of at least a subset 208 of modified NAP 24 e.g., as part of an MBP capability 134, in accordance with an example implementation.

As illustrated computing platform 900 may comprise one or more processing units 902 (e.g., to perform data processing in accordance with the techniques provided herein, and/or apparatus 104, etc.) coupled to memory 904 via one or more connections 906. Processing unit(s) 902 may, for example, be implemented in hardware or a combination of hardware and software. Processing unit(s) 902 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 904 may be representative of any data storage mechanism. Memory 904 may include, for example, a primary memory 904-1 and/or a secondary memory 904-2. Primary memory 904-1 may comprise, for example, a random access memory, read only memory, etc. While illustrated in this example as being separate from the processing units, it should be understood that all or part of a primary memory may be provided within or otherwise co-located/coupled with processing unit(s) 902, or other like circuitry within mobile device 102. Secondary memory 904-2 may comprise, for example, the same or similar type of memory as primary memory and/or one or more data storage devices or systems, such as, for example, a disk drive, an optical disc drive, a tape drive, a solid motion state memory drive, etc

In certain implementations, secondary memory may be operatively receptive of, or otherwise configurable to couple to, a non-transitory computer readable medium 970. Memory 904 and/or non-transitory computer readable medium 970 may comprise instructions 972 for use in performing data processing, e.g., in accordance with the applicable techniques as provided herein.

Computing platform 900 may, for example, further comprise one or more communication interface(s) 908. Communication interface(s) 908 may, for example, comprise one or more radios, represented here by one or more receivers 910 and one or more transmitters 912. It should be understood that in certain implementations, communication interface 908 may comprise one or more transceivers, and/or the like. Further, it should be understood that although not shown, communication interface 908 may comprise one or more antennas and/or other circuitry as may be applicable given the radios function/capability.

By way of further example, communication interface(s) 908 may, for example, provide connectivity to network(s) 110, one or more receivers 128, one or more receivers 144, one or more transmitters 138, one or more transmitters 146, and/or one or more other electronic devices 118 (FIG. 1), e.g., via one or more wired and/or wireless communication links. Communication interface(s) 908 may implement one or more communication protocols as may be required to support one or more wired and/or wireless communication links.

In certain example instances, mobile device 102 may comprise an SPS receiver 918 capable of acquiring and processing SPS signals 152 in support of one or more signal-based positioning capabilities.

In accordance with certain example implementations, communication interface(s) 908, communication interface(s) 1008 (FIG. 10), one or more receivers 128, one or more receivers 144, one or more transmitters 138, one or more transmitters 146, and/or network(s) 110 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMBP capability), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like. Additionally, communication interface(s) 208 and/or communication interface(s) 908 may further provide for infrared-based communications with one or more other devices. A WLAN may, for example, comprise an IEEE 802.11x network, and a WPAN may comprise a Bluetooth network, an IEEE 802.15x, for example. Wireless communication implementations described herein may also be used in connection with any combination of WWAN, WLAN or WPAN. In another aspect, a wireless transmitting device may comprise a femtocell, utilized to extend cellular telephone service into a business or home. In such an implementation, one or more mobile devices may communicate with a femtocell via a CDMA cellular communication protocol, for example, and the femtocell may provide the mobile device access to a larger cellular telecommunication network by way of another broadband network such as the Internet.

Mobile device 102 may, for example, further comprise one or more input/output units 914. Input/output units 914 may represent one or more devices or other like mechanisms that may be used to obtain inputs from and/or provide outputs to one or more other devices and/or a user of mobile device 102. Thus, for example, input/output units 914 may comprise various buttons, switches, a touch pad, a trackball, a joystick, a touch screen, a microphone, a camera, and/or the like, which may be used to receive one or more user inputs. In certain instances, input/output units 914 may comprise various devices that may be used in producing a visual output, an audible output, and/or a tactile output for a user. For example, input/output units 914 may be used to present a solicitation to the user and to obtain certain corresponding user inputs.

Mobile device 102 may, for example, comprise one or more sensors 916. For example, sensor(s) 916 may represent one or more inertial sensors, one or more environmental sensors, etc., which may be useful in detecting aspects of the environment 108 and/or mobile device 102. Thus for example, sensor(s) 916 may comprise one or more accelerometers, one or one or more gyroscopes or gyrometers, one or more magnetometers and/or the like, one or more barometers, one or more thermometers, etc. Further, in certain instances sensor(s) 916 may comprise one or more input devices such as a microphone, a camera, a light sensor, etc.

SPS receiver 918 may be capable of acquiring and acquiring SPS signals 152 via one or more antennas (not shown). SPS receiver 918 may also process, in whole or in part, acquired SPS signals 152 for estimating a position or location of mobile device 102. In certain instances, SPS receiver 918 may comprise one or more processing unit(s) (not shown), e.g., one or more general purpose processors, one or more digital signal processors DSP(s), one or more specialized processors that may also be utilized to process acquired SPS signals, in whole or in part, and/or calculate an estimated location of mobile device 102. In certain implementations, all or part of such processing of acquired SPS signals may be performed by other processing capabilities in mobile device 102, e.g., processing unit(s) 902, memory 904, etc., in conjunction with SPS receiver 918. Storage of SPS or other signals for use in performing positioning operations may be performed in memory 904 or registers (not shown).

Sensors 916 may generate analog or digital signals that may be stored in memory 904 and processed by DPS(s) (not shown) or processing unit(s) 902 in support of one or more applications such as, for example, applications directed to positioning or navigation operations.

Processing unit(s) 902 may comprise a dedicated modem processor or the like that may be capable of performing baseband processing of signals acquired and downconverted at receiver(s) 910 of communication interface(s) 908 or SPS receiver 918. Similarly, a modem processor or the like may perform baseband processing of signals to be upconverted for transmission by wireless transmitter(s) 912. In alternative implementations, instead of having a dedicated modem processor, baseband processing may be performed by a general purpose processor or DSP (e.g., general purpose/application processor). It should be understood, however, that these are merely examples of structures that may perform baseband processing, and that claimed subject matter is not limited in this respect.

FIG. 10 is a schematic block diagram illustrating certain features of a computing platform 1000 that may be provided in an electronic device (e.g. other device 118, device 126, or device 136) to provide modified NAP, and/or at least a subset of modified NAP to at least one other electronic device and/or a mobile device, in accordance with an example implementation.

As illustrated computing platform 1000 may comprise one or more processing units 1002 (e.g., to perform data processing in accordance with the techniques provided herein) coupled to memory 1004 via one or more connections 1006. Processing unit(s) 1002 may, for example, be implemented in hardware or a combination of hardware and software. Processing unit(s) 1002 may be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, or the like, or any combination thereof.

Memory 1004 may be representative of any data storage mechanism. Memory 1004 may include, for example, a primary memory 1004-1 and/or a secondary memory 1004-2. Primary memory 1004-1 may comprise, for example, a random access memory, read only memory, etc. While illustrated in this example as being separate from the processing units, it should be understood that all or part of a primary memory may be provided within or otherwise co-located/coupled with processing unit(s) 1002, or other like circuitry within mobile device 102. Secondary memory 1004-2 may comprise, for example, the same or similar type of memory as primary memory and/or one or more data storage devices or systems, such as, for example, a disk drive, an optical disc drive, a tape drive, a solid motion state memory drive, etc

In certain implementations, secondary memory may be operatively receptive of, or otherwise configurable to couple to, a non-transitory computer readable medium 1070. Memory 1004 and/or non-transitory computer readable medium 1070 may comprise instructions 1072 for use in performing data processing, e.g., in accordance with the applicable techniques as provided herein.

Computing platform 1000 may, for example, further comprise one or more communication interface(s) 1008. Communication interface(s) 1008 may, for example, comprise one or more radios, represented here by one or more receivers 1010 and one or more transmitters 1012. It should be understood that in certain implementations, communication interface 1008 may comprise one or more transceivers, and/or the like. Further, it should be understood that although not shown, communication interface 1008 may comprise one or more antennas and/or other circuitry as may be applicable given the radios function/capability.

By way of further example, communication interface(s) 1008 may, for example, provide connectivity to network(s) 110, one or more receivers 128, one or more receivers 144, one or more transmitters 138, one or more transmitters 146, mobile device 102, and/or one or more other electronic devices 118 (FIG. 1), e.g., via one or more wired and/or wireless communication links. Communication interface(s) 1008 may implement one or more communication protocols as may be required to support one or more wired and/or wireless communication links.

In accordance with certain further aspects of the present description, various enhancements may be provided to all or part of an NBP capability and/or an MBP capability which may improve their performance and/or otherwise possibly further assist supporting the techniques provided herein for modifying NAP, etc.

By way of example, in certain implementations when a person carrying a mobile device enters into a building and/or other like indoor environment, an NBP capability may determine an estimated initial position 232 using various known techniques, e.g., such as a brute force Maximum Likelihood (or similar approach) making use of the likely more abundant processing power at one or more electronic devices that are part of the NBP capability. Here, for example, an estimated initial position 232 may be provided to an MBP server and/or the like and forwarded the mobile device along with NAP, modified NAP, a subset of modified NAP, and/or the like or some combination thereof. Accordingly, an added burden of obtaining a reasonable estimated initial position via the MBP capability may be reduced. Further, having a reasonable estimated initial position may be useful to the mobile device for other reasons, e.g., to calibrate receiver processing gains and RTT processing delays, etc.

In certain example implementations, a decision may be made to select between an NBP or an MBP capability, and/or to assign tasks to such capabilities and/or obtain certain information from such capabilities, e.g., depending on the particular environment, the NBP capability, the MBP capability, certain operating in/or user preferences, a preferred NAP or modified NAP update frequency or life span, a desired level of accuracy, certain data/service plan considerations, available processing capabilities, conserving power in the mobile device, etc.

In certain instances, such a decision(s) may take into consideration the number of mobile devices, e.g. within a particular environment and/or currently being served by an NBP capability. For example, an NBP capability may have a limit as to the number of mobile devices that it may track, and/or provide other services/information to, including, for example certain types of NAP, modified NAP, etc. Accordingly, at times, it may be useful for an NBP capability influence a decision to use all or part of an MBP capability. In certain instances, such decisions may take into account the processing capability and/or other operational capabilities of one or more mobile devices, e.g. so as to select mobile devices to use an MBP capability are certain aspects thereof rather than an MBP capability or portion thereof.

In certain example implementations, such decisions may also take into consideration certain changes that may occur with regard to one or more transmitters supporting an MBP capability within a particular environment. Here, for example, one or more transmitters may have been relocated recently, may have had their operation change in some manner, and/or may have stopped functioning. Thus, for example, an NBP capability having detected such changes within the particular environment may share such information with an MBP capability and/or directly or indirectly with a mobile device, e.g., via modified NAP and/or a subset thereof.

In accordance with yet another aspect, in certain example implementations, certain information that may be obtained via the techniques provided herein may be of use by both an MBP capability and an NBP capability. For example, certain signaling-related measurements and/or the like which may be considered for use in modifying NAP may also be considered for use in calibrating otherwise affecting the operation of an MBP capability and/or an NBP capability. Thus, for example, let us assume that a mobile device measures an RSSI from a transmitter which differs from an expected RSSI at the same location (e.g., from a probability radio heatmap, etc.). Such a difference in RSSI may, for example, correspond to a change in transmit power at the transmitter, possibly a change in gain at the mobile device, and/or possibly a change in the environment through which the signals propagate. It may be beneficial, for example, if a network reports a measured RSSI for one or more signals from the mobile device back to the mobile device (e.g., via modified, etc.). Accordingly, a mobile device with such information may be able to use additional knowledge regarding mobile transmit power in determining a one-way path loss, which may, for example, be used to calibrate processing gains.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically motion stated otherwise, as apparent from the following discussion, it is appreciated that throughout this specification discussions utilizing terms such as “processing,” “computing,” “calculating,” “determining”, “generating”, “obtaining”, “modifying”, “selecting,” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, with at least one computing platform:
obtaining navigation assistance parameters (NAP) for a mobile device within a particular environment, said NAP for use, at least in part, by said mobile device to estimate its movement and/or position within said particular environment based, at least in part, on one or more wireless signals acquired by said mobile device as part of a mobile-based positioning (MBP) capability;
modifying said NAP based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
providing at least a portion of said modified NAP to at least one electronic device of said MBP capability.

2. The method as recited in claim 1, and further comprising, with said at least one computing platform:
determining an uncertainty or accuracy of said movements and/or positions for at least said at least one of said plurality of mobile devices; and
wherein said modifying said NAP is further based, at least in part, at least said determined uncertainty or accuracy.

3. The method as recited in claim 1, and further comprising, with said at least one computing platform:
requesting and/or obtaining said observations from at least one electronic device of said NBP capability.

4. The method as recited in claim 1, wherein said portion of said modified NAP comprises a routability graph corresponding to at least a portion of said particular environment.

5. The method as recited in claim 1, wherein said portion of said modified NAP comprises a probability radio heatmap corresponding to at least one transmitter.

6. The method as recited in claim 1, and further comprising, with said at least one computing platform:
obtaining at least a portion of said NAP from said at least one electronic device of said MBP capability.

7. The method as recited in claim 1, and further comprising, with said at least one computing platform, one of:
obtaining a request for NAP from said at least one electronic device of said MBP capability; or
transmitting a message requesting NAP to said at least one electronic device of said MBP capability.

8. The method as recited in claim 1, and further comprising, with said at least one computing platform:
obtaining an initial estimated position of said mobile device relative to said particular environment, said initial estimated position being based, at least in part, on one or more signals transmitted by said mobile device and acquired by at least said at least one receiver; and
providing said initial estimated position of said mobile device to at least said at least one electronic device of said MBP capability.

9. The method as recited in claim 1, wherein said at least one electronic device of said MBP capability comprises an MBP capability server.

10. The method as recited in claim 1, wherein said at least one electronic device of said MBP capability comprises said mobile device.

11. An apparatus comprising:
means for obtaining navigation assistance parameters (NAP) for a mobile device within a particular environment, said NAP for use, at least in part, by said mobile device to estimate its movement and/or position within said particular environment based, at least in part, on one or more wireless signals acquired by said mobile device as part of a mobile-based positioning (MBP) capability;
means for modifying said NAP based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
means for providing at least a portion of said modified NAP to at least one electronic device of said MBP capability.

12. The apparatus as recited in claim 11, and further comprising:
means for determining an uncertainty or accuracy of said movements and/or positions for at least said at least one of said plurality of mobile devices; and
means for modifying said NAP further based, at least in part, at least said determined uncertainty or accuracy.

13. The apparatus as recited in claim 11, and further comprising, at least one of:
means for requesting said observations from at least one electronic device of said NBP capability; or
means for obtaining said observations from said at least one electronic device of said NBP capability.

14. The apparatus as recited in claim 11, wherein said portion of said modified NAP comprises a routability graph corresponding to at least a portion of said particular environment.

15. The apparatus as recited in claim 11, wherein said portion of said modified NAP comprises a probability radio heatmap corresponding to at least one transmitter.

16. The apparatus as recited in claim 11, and further comprising:
means for obtaining at least a portion of said NAP from said at least one electronic device of said MBP capability.

17. The apparatus as recited in claim 11, and further comprising, one of:
means for obtaining a request for NAP from said at least one electronic device of said MBP capability; or
means for transmitting a message requesting NAP to said at least one electronic device of said MBP capability.

18. The apparatus as recited in claim 11, and further comprising:
means for obtaining an initial estimated position of said mobile device relative to said particular environment, said initial estimated position being based, at least in part, on one or more signals transmitted by said mobile device and acquired by at least said at least one receiver; and
means for providing said initial estimated position of said mobile device to at least said at least one electronic device of said MBP capability.

19. The apparatus as recited in claim 11, wherein said at least one electronic device of said MBP capability comprises an MBP capability server.

20. The apparatus as recited in claim 11, wherein said at least one electronic device of said MBP capability comprises said mobile device.

21. An apparatus comprising:
a communication interface; and
a processing unit to:
access navigation assistance parameters (NAP) for a mobile device within a particular environment, said NAP for use, at least in part, by said mobile device to estimate its movement and/or position within said particular environment based, at least in part, on one or more wireless signals acquired by said mobile device as part of a mobile-based positioning (MBP) capability;
modify said NAP based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
initiate transmission of at least a portion of said modified NAP to at least one electronic device of said MBP capability via said communication interface.

22. The apparatus as recited in claim 21, said processing unit to further:
determine an uncertainty or accuracy of said movements and/or positions for at least said at least one of said plurality of mobile devices; and
modify said NAP further based, at least in part, at least said determined uncertainty or accuracy.

23. The apparatus as recited in claim 21, said processing unit to further:
initiate transmission, via said communication interface, of a request for said observations from at least one electronic device of said NBP capability; and/or
obtain said observations from said at least one electronic device of said NBP capability via said communication interface.

24. The apparatus as recited in claim 21, wherein said portion of said modified NAP comprises a routability graph corresponding to at least a portion of said particular environment.

25. The apparatus as recited in claim 21, wherein said portion of said modified NAP comprises a probability radio heatmap corresponding to at least one transmitter.

26. The apparatus as recited in claim 21, said processing unit to further:
obtain, via said communication interface, at least a portion of said NAP from said at least one electronic device of said MBP capability.

27. The apparatus as recited in claim 21, said processing unit to further:
obtain, via said communication interface, a request for NAP from said at least one electronic device of said MBP capability; or
initiate transmission of a message requesting NAP to said at least one electronic device of said MBP capability, via said communication interface.

28. The apparatus as recited in claim 21, said processing unit to further:
obtain an initial estimated position of said mobile device relative to said particular environment, said initial estimated position being based, at least in part, on one or more signals transmitted by said mobile device and acquired by at least said at least one receiver; and
initiate transmission, via said communication interface, of said initial estimated position of said mobile device to at least said at least one electronic device of said MBP capability.

29. The apparatus as recited in claim 21, wherein said at least one electronic device of said MBP capability comprises an MBP capability server.

30. The apparatus as recited in claim 21, wherein said at least one electronic device of said MBP capability comprises said mobile device.

31. An article comprising:
a non-transitory computer readable medium having stored therein computer implementable instructions executable by at least one processor in a network-based positioning (NBP) capability to:
obtain navigation assistance parameters (NAP) for a mobile device within a particular environment, said NAP for use, at least in part, by said mobile device to estimate its movement and/or position within said particular environment based, at least in part, on one or more wireless signals acquired by said mobile device as part of a mobile-based positioning (MBP) capability;
modify said NAP based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
initiate transmission of at least a portion of said modified NAP to at least one electronic device of said MBP capability.

32. The article as recited in claim 31, said computer readable instructions being further executable to:
determine an uncertainty or accuracy of said movements and/or positions for at least said at least one of said plurality of mobile devices; and
modify said NAP further based, at least in part, at least said determined uncertainty or accuracy.

33. The article as recited in claim 31, said computer readable instructions being further executable to:
initiate transmission of a request for said observations from at least one electronic device of said NBP capability; and/or
obtain said observations from said at least one electronic device of said NBP capability via said communication interface.

34. The article as recited in claim 31, wherein said portion of said modified NAP comprises a routability graph corresponding to at least a portion of said particular environment.

35. The article as recited in claim 31, wherein said portion of said modified NAP comprises a probability radio heatmap corresponding to at least one transmitter.

36. The article as recited in claim 31, said computer readable instructions being further executable to:
obtain at least a portion of said NAP from said at least one electronic device of said MBP capability.

37. The article as recited in claim 31, said computer readable instructions being further executable to:
obtain a request for NAP from said at least one electronic device of said MBP capability; or
initiate transmission of a message requesting NAP to said at least one electronic device of said MBP capability.

38. The article as recited in claim 31, said computer readable instructions being further executable to:
obtain an initial estimated position of said mobile device relative to said particular environment, said initial estimated position being based, at least in part, on one or more signals transmitted by said mobile device and acquired by at least said at least one receiver; and
initiate transmission of said initial estimated position of said mobile device to at least said at least one electronic device of said MBP capability.

39. The article as recited in claim 31, wherein said at least one electronic device of said MBP capability comprises an MBP capability server.

40. The article as recited in claim 31, wherein said at least one electronic device of said MBP capability comprises said mobile device.

41. A method comprising, with at least one computing platform in a mobile-based positioning (MBP) capability:
obtaining navigation assistance parameters (NAP) for a mobile device within a particular environment from at least one electronic device, wherein at least a portion of said NAP has been modified based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
providing at least a portion of said modified NAP to a positioning capability of said mobile device for use in estimating a position and/or a movement of said mobile device within said particular environment based, at least in part, on one or more wireless signals acquired by said mobile device as part of said MBP capability.

42. The method as recited in claim 41, wherein said at least said portion of said modified NAP comprises only a subset of said modified NAP; and
further comprising, with said at least one computing platform in said MBP capability:
selecting said subset of said modified NAP.

43. The method as recited in claim 41, wherein said portion of said modified NAP comprises a routability graph corresponding to at least a portion of said particular environment.

44. The method as recited in claim 41, wherein said portion of said modified NAP comprises a probability radio heatmap corresponding to at least one transmitter.

45. The method as recited in claim 41, and further comprising, with said at least one computing platform in said MBP capability:
transmitting a request for NAP to said at least one electronic device.

46. The method as recited in claim 41, and further comprising, with said at least one computing platform in said MBP capability:
obtaining an initial estimated position of said mobile device relative to said particular environment from said at least one electronic device, said initial estimated position being calculated based, at least in part, on one or more signals transmitted by said mobile device and received by at least said at least one receiver.

47. The method as recited in claim 41, wherein said at least one computing platform of said MBP capability comprises an MBP capability server.

48. The method as recited in claim 41, wherein said at least one computing platform of said MBP capability comprises said mobile device.

49. An apparatus for use in providing a mobile-based positioning (MBP) capability, the apparatus comprising:
means for obtaining navigation assistance parameters (NAP) for a mobile device within a particular environment from at least one electronic device, wherein at least a portion of said NAP has been modified based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
means for providing at least a portion of said modified NAP to a positioning capability of said mobile device for use in estimating a position and/or a movement of said mobile device within said particular environment based, at least in part, on one or more wireless signals acquired by said mobile device as part of said MBP capability.

50. The apparatus as recited in claim 49, wherein said at least said portion of said modified NAP comprises only a subset of said modified NAP; and
further comprising:
means for selecting said subset of said modified NAP.

51. The apparatus as recited in claim 49, wherein said portion of said modified NAP comprises a routability graph corresponding to at least a portion of said particular environment.

52. The apparatus as recited in claim 49, wherein said portion of said modified NAP comprises a probability radio heatmap corresponding to at least one transmitter.

53. The apparatus as recited in claim 49, and further comprising:
means for transmitting a request for NAP to said at least one electronic device.

54. The apparatus as recited in claim 49, and further comprising:
means for obtaining an initial estimated position of said mobile device relative to said particular environment from said at least one electronic device, said initial estimated position being calculated based, at least in part, on one or more signals transmitted by said mobile device and received by at least said at least one receiver.

55. The apparatus as recited in claim 49, wherein said at least one computing platform of said MBP capability comprises an MBP capability server.

56. The apparatus as recited in claim 49, wherein said at least one computing platform of said MBP capability comprises said mobile device.

57. An apparatus for use in a mobile-based positioning (MBP) capability, the apparatus comprising:
a communication interface; and
a processing unit to:
obtain, via said communication interface, navigation assistance parameters (NAP) for a mobile device within a particular environment from at least one electronic device, wherein at least a portion of said NAP has been modified based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
provide at least a portion of said modified NAP to a positioning capability of said mobile device for use in estimating a position and/or a movement of said mobile device within said particular environment based, at least in part, on one or more wireless signals acquired by said mobile device as part of said MBP capability.

58. The apparatus as recited in claim 57, wherein said at least said portion of said modified NAP comprises only a subset of said modified NAP; and
said processing unit to further:
select said subset of said modified NAP.

59. The apparatus as recited in claim 57, wherein said portion of said modified NAP comprises a routability graph corresponding to at least a portion of said particular environment.

60. The apparatus as recited in claim 57, wherein said portion of said modified NAP comprises a probability radio heatmap corresponding to at least one transmitter.

61. The apparatus as recited in claim 57, said processing unit to further:
initiate transmission, via said communication interface, of a request for NAP to said at least one electronic device.

62. The apparatus as recited in claim 57, said processing unit to further:
obtain an initial estimated position of said mobile device relative to said particular environment from said at least one electronic device via said communication interface, said initial estimated position being calculated based, at least in part, on one or more signals transmitted by said mobile device and received by at least said at least one receiver.

63. The apparatus as recited in claim 57, wherein said apparatus comprises an MBP capability server.

64. The apparatus as recited in claim 57, wherein said apparatus comprises said mobile device.

65. An article comprising:
a non-transitory computer readable medium having stored therein computer implementable instructions executable by at least one processor in a mobile-based positioning (MBP) capability to:
obtain navigation assistance parameters (NAP) for a mobile device within a particular environment from at least one electronic device, wherein at least a portion of said NAP has been modified based, at least in part, on observations of movements and/or positions of a plurality of mobile devices within said particular environment gathered by a network-based positioning (NBP) capability, wherein at least a portion of said observations is based, at least in part, on one or more signal characteristics for one or more signals transmitted by at least one of said plurality of mobile devices and acquired by at least one receiver; and
provide at least a portion of said modified NAP to a positioning capability of said mobile device for use in estimating a position and/or a movement of said mobile device within said particular environment based, at least in part, on one or more wireless signals acquired by said mobile device as part of said MBP capability.

66. The article as recited in claim 65, wherein said at least said portion of said modified NAP comprises only a subset of said modified NAP; and
said computer readable instructions being further executable to:
select said subset of said modified NAP.

67. The article as recited in claim 65, wherein said portion of said modified NAP comprises a routability graph corresponding to at least a portion of said particular environment.

68. The article as recited in claim 65, wherein said portion of said modified NAP comprises a probability radio heatmap corresponding to at least one transmitter.

69. The article as recited in claim 65, said computer readable instructions being further executable to:
initiate transmission of a request for NAP to said at least one electronic device.

70. The article as recited in claim 65, said computer readable instructions being further executable to:
obtain an initial estimated position of said mobile device relative to said particular environment from said at least one electronic device, said initial estimated position being calculated based, at least in part, on one or more signals transmitted by said mobile device and received by at least said at least one receiver.

71. The article as recited in claim 65, wherein said at least one computing platform of said MBP capability comprises an MBP capability server.

72. The article as recited in claim 65, wherein said at least one computing platform of said MBP capability comprises said mobile device.
